(19) United States
(12) Patent Application Publication
(10) Pub. No.: US 2011/0101771 A1
(43) Pub. Date: May 5, 2011

(54) STEERING AXLE

(76) Inventor: Oswaldo De Freitas Junior, Oakland Twp., MI (US)

(21) Appl. No.: 12/612,462

(22) Filed: Nov. 4, 2009

(51) Int. Cl. B60B 35/08

(52) U.S. Cl. 301/124.1

(57) ABSTRACT

One embodiment of a steering axle may include a hollow tube having a pair of end portions. The steering axle may also include a pair of inserts coupled to a respective one of the end portions for reinforcing the same.

### FIELD OF THE DISCLOSURE

The present disclosure generally relates to automotive components, and more particularly, to a steering axle for vehicles, such as commercial heavy trucks and trailers.

### BACKGROUND OF THE DISCLOSURE

A steering mechanism of a vehicle includes a front or an auxiliary non-drive steering axle (hereinafter referred to as “steering axle”) carried by a pair of wheels to support torsional and bending loads in connection with those wheels. The steering axle may be mounted between the front wheels of a rear wheel drive vehicle. Specifically, each front wheel may have a knuckle, and the steering axle may have a pair of end portions coupled to a respective one of the knuckles by a kingpin. Of course, the steering axle may instead be an auxiliary axle on the rear of the front axle, on the rear of the rear axle, or in a trailer.

The steering mechanism further includes a pair of kingpin bosses, which may be integral parts of the steering axle beam or welded onto the beam. The kingpin bosses may need to be welded in high-stress areas and may require a long length of welding.

### SUMMARY OF THE DISCLOSURE

One embodiment of a steering axle may include a hollow tube having a pair of end portions. The steering axle may also include a pair of inserts coupled to a respective one of the end portions for reinforcing the same.

### BRIEF DESCRIPTION OF THE DRAWING

The advantages and features of the present disclosure will become better understood with reference to the detailed description taken in conjunction with the accompanying drawings, in which:

FIG. 1 is a perspective view of one embodiment of a steering axle;

FIG. 2 is a front view of the steering axle of FIG. 1, showing the steering axle having a vertically offset configuration;

FIG. 3 is a cross-sectional view taken along line 3-3 of FIG. 2;

FIG. 4 is a top view of the steering axle of FIG. 1;

FIG. 5 is a cross-sectional view taken along line 5-5 of FIG. 4;

FIG. 6 is an exploded view of one end portion of the steering axle of FIG. 1;

FIG. 7 is an enlarged view of one end portion of the steering axle of FIG. 1;

FIG. 8 is a cross-sectional view of the end portion of FIG. 1, showing the end portion pivotally carried by a knuckle;

FIG. 9 is an enlarged view of another embodiment of an end portion of a steering axle;

FIG. 10 is a cross-sectional view taken along line 10-10 of FIG. 9, showing the steering axle having an end portion and an insert joined with the end portion by plug welding;

FIG. 11 is an enlarged view of yet another embodiment of an end portion of a steering axle;

FIG. 12 is a cross-sectional view taken along line 12-12 of FIG. 11, showing the steering axle having an end portion and an insert joined with the end portion by point welding;

FIG. 13 is an enlarged view of still another embodiment of an end portion of a steering axle;

FIG. 14 is a cross-sectional view taken along line 14-14 of FIG. 13, showing the steering axle having an end portion and an insert joined with the end portion by bolt fasteners;

FIG. 15 is a cross sectional view of another embodiment of a steering axle, showing the steering axle including an end portion that has a top wall and a bottom partially formed around an insert to hold the insert within the end portion;

FIG. 16 is a cross sectional view of still another embodiment of a steering axle, showing the steering axle having an end portion and an insert press-fit within the end portion;

FIG. 17 is a cross sectional view of another embodiment of a steering axle, showing the steering axle including an end portion that has a pair of sidewalls partially formed around an insert to hold the insert within the end portion;

FIG. 18 is a front view of another embodiment of a steering axle; and

FIG. 19 is a top view of the steering axle of FIG. 18, showing the steering axle having a horizontally offset configuration.

Like reference numerals refer to like parts throughout the description of several views of the drawings.

### DETAILED DESCRIPTION OF THE DISCLOSURE

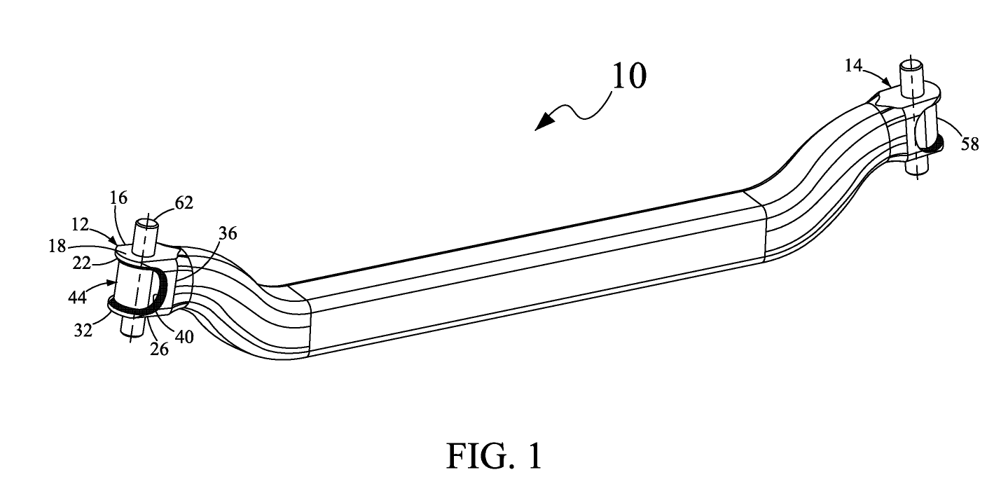

Exemplary modes for carrying out the disclosure are presented and depicted in FIGS. 1 to 19. The exemplary embodiments described herein provide detail for illustrative purposes only and are subject to many variations. It is understood that various omissions and substitutions of equivalents are contemplated as circumstances may suggest or render expedient, but are intended to cover the application or implementation without departing from the spirit or scope of the present disclosure.

The terms “a” and “an” herein do not denote a limitation of quantity, but rather denote the presence of at least one of the referenced item.

One embodiment of a front or an auxiliary non-drive steering axle (hereinafter referred to as “steering axle”) may be used in a steering mechanism for a truck, a bus, a trailer, or any other suitable vehicle. The steering axle may reduce high-stress welding and long length welding of kingpin bosses in welded beams of steering axles.

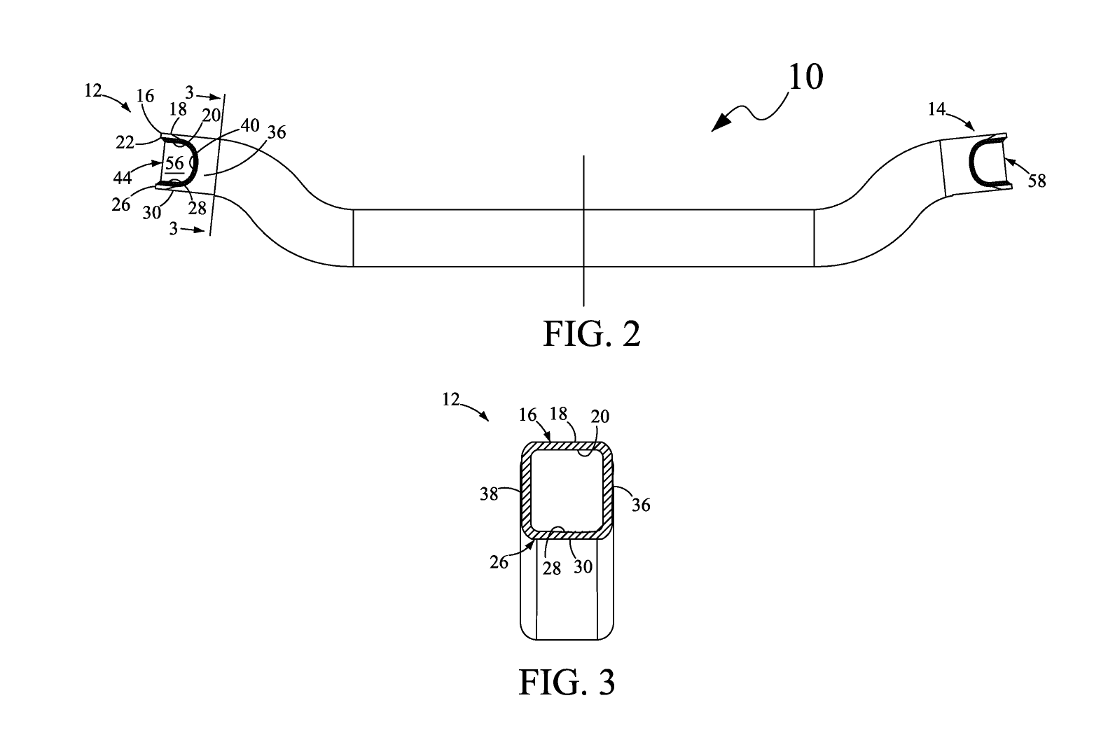

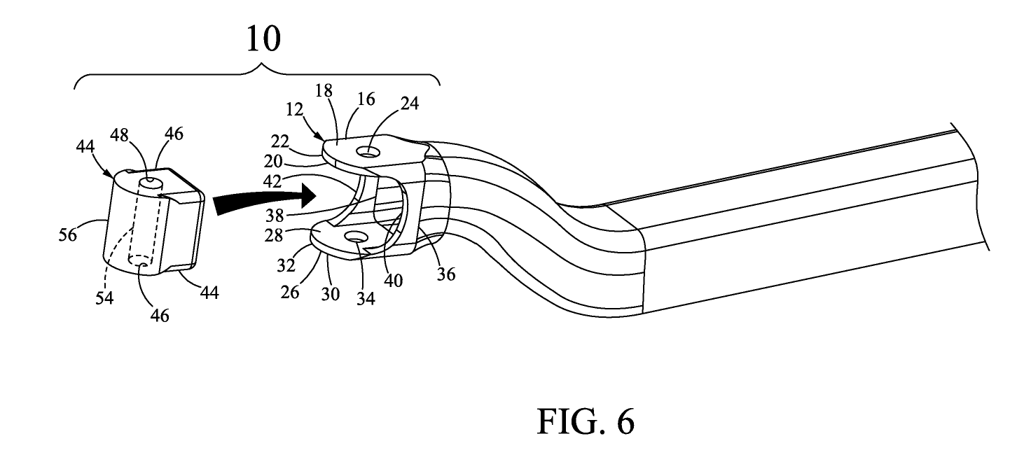

Referring to FIGS. 1 and 2, one embodiment of a steering axle 10 may include a hollow metal axle tube having a pair of end portions 12, 14, which in this form may be identical to each other. For brevity, only end portion 12 will be discussed in detail. As best shown in FIG. 3, the end portion 12 may include a top wall 16 having an upper or outer surface 18 and a lower or inner surface 20, which in one form may terminate at a convex edge 22 (FIG. 6) thereby providing the top wall 16 with a semi-circular shape. Of course, the wall 16 may have other suitable shapes. The top wall 16 may also have a hole 24 extending between the upper and lower surfaces 18, 20. In addition, the end portion 12 may also include a bottom wall 26 spaced apart from the top wall 16. The bottom wall 26 may have an upper or inner surface 28 and a lower or outer surface 30, which in one form may terminate at a convex edge 32 (FIG. 6) thereby providing the bottom wall 26 with a semi-circular shape. Of course, the bottom wall 26 may have other suitable shapes. The bottom wall 26 may also have a hole 34, which may extend between the upper and lower surfaces 28, 30 and may be aligned with the hole 24. Further, as shown in FIG. 3, the end portion 12 may also include a pair of sidewalls 36, 38, extending between the top and bottom walls 16, 26 to provide a polygonal cross-section, such as a rectangular cross-section. Of course, the end portion may instead have a cross-section with circular, oval, elliptical or other suitable shapes. The sidewalls 36, 38 may terminate along a length of the steering axle 10 with a respective one of concave edges 40, 42 (FIG. 6), which in one form may be cutouts in the sidewalls of the hollow axle tube. However, the sidewalls 36, 38 may include edges having other shapes, such as rectangular or square cutouts.

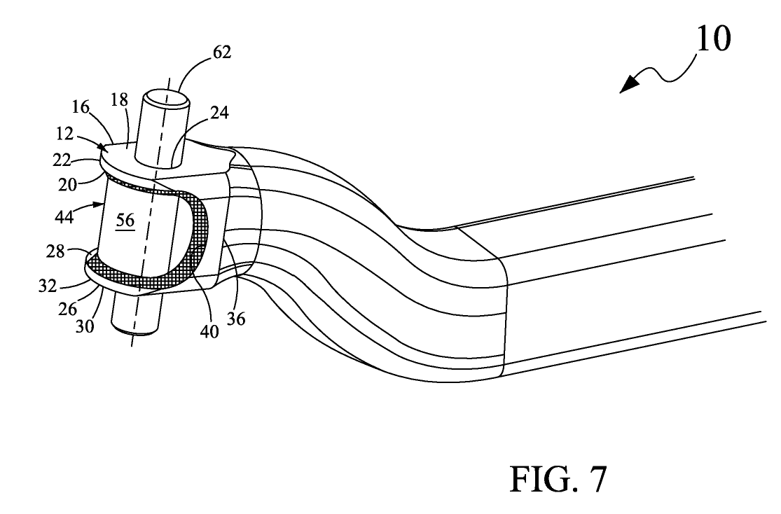

Referring to FIGS. 5-7, the steering axle 10 also includes an insert 44 carried by the end portion 12. The insert 44 in this form may be received within the end portion 12 between the top and bottom walls 16, 26 and the sidewalls 36, 38. As best shown in FIG. 5, the insert 44 may have a top surface 46 that may include an aperture 48. The insert 44 may further have a bottom surface 50, which may be spaced apart from the top surface 46 and may include an aperture 52. Further, the insert may have a passage 54 terminating on one end with the aperture 48 and terminating on another end with the aperture 52. In addition, the insert 44 may also have one or more sidewalls 56, which may extend between the top and bottom surfaces 46, 50. As best shown in FIG. 7, the sidewalls 56 may be welded to the lower or inner surface 20 of the top wall 16, the upper or inner surface 28 of the bottom wall 26, and the concave edges 40, 42 of a respective one of the sidewalls 36, 38. The steering axle 10 in this form may have no other weld joint or other connection between the insert 44 and the end portion 12. It is contemplated that the passage 54, the apertures 48, 52 and the holes 24, 34 may be formed after the insert 44 is joined with the end portion 12. In addition, the insert 44 may have other suitable surfaces and may have other apertures and passages or omit the one or more of the apertures and passage.

Referring back to FIG. 1, the steering axle 10 also includes another insert 58 that may be carried by the end portion 14 in a similar fashion as the insert 44 is carried by the end portion 12. However, it is contemplated that the insert 58 may be joined with the end portion 14 by a fastening method different from that of the insert 44 and the end portion 12.

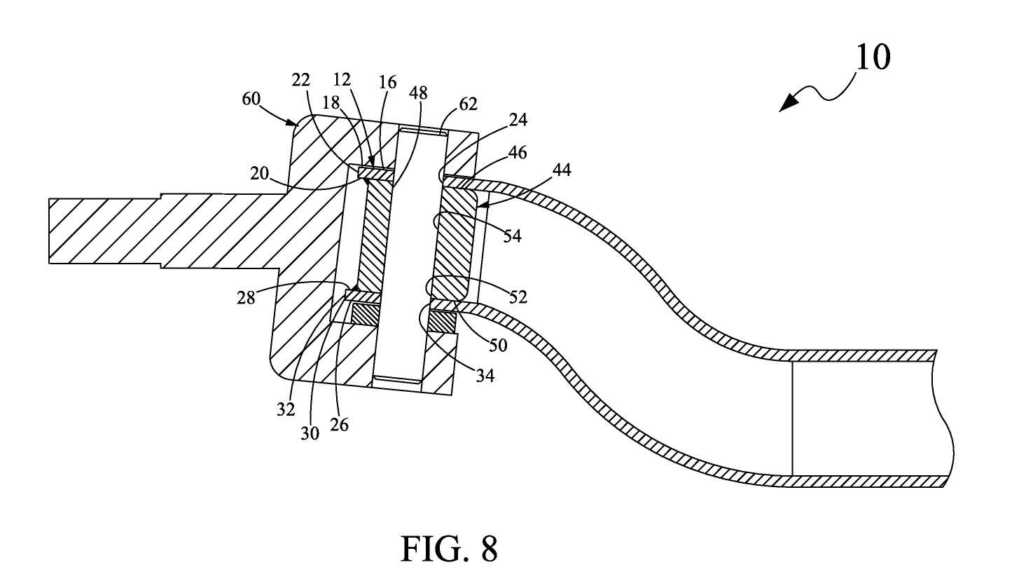

Referring to FIG. 8, the end portion 12 may be pivotally carried by a knuckle 60 that may extend from a wheel (not shown). The knuckle 60 in one form may receive the end portion 12, and a kingpin 62 may be received through the knuckle 60, the holes 24, 34 and the passage 54, such that the kingpin 62 pivotally interconnects the knuckle 60 and the end portion 12. The convex edges 22, 32 of the end portion 12 may provide clearance for the knuckle 60 to pivot on the end portion 12. Similarly, the end portion 14 opposite to the end portion 14 may be coupled to another knuckle (not shown) and further coupled with another wheel (not shown) as described above.

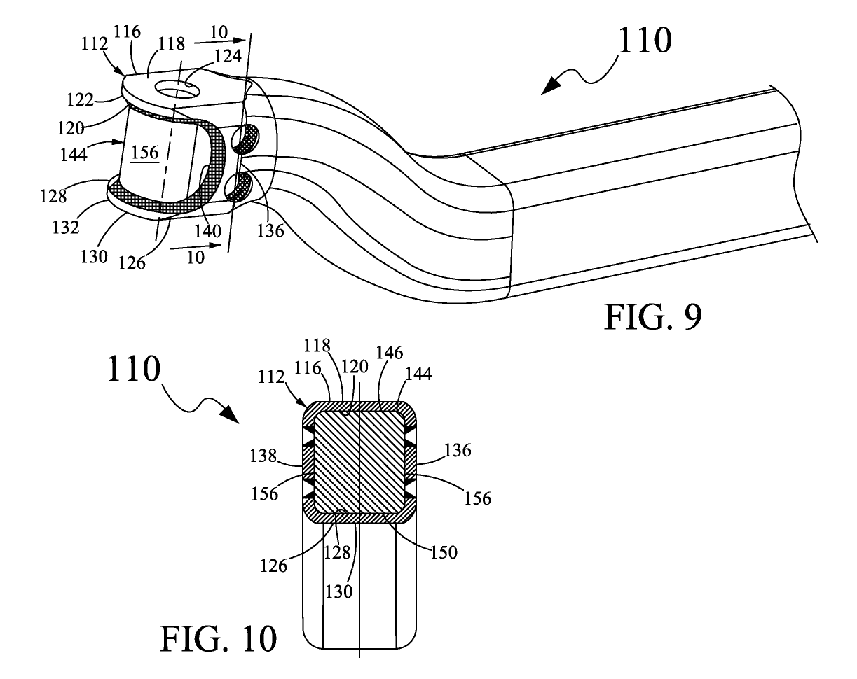

Referring to FIGS. 9 and 10, another embodiment of a steering axle 110 may include a hollow axle tube having an end portion 112 and an insert 144 carried by the end portion 112. The steering axle 110 may be substantially similar to the steering axle 10 of FIGS. 2 and 3. However, the sidewalls 156 of the insert 144 may be further joined with the sidewalls 136, 138 of the end portion 112 by plug welding.

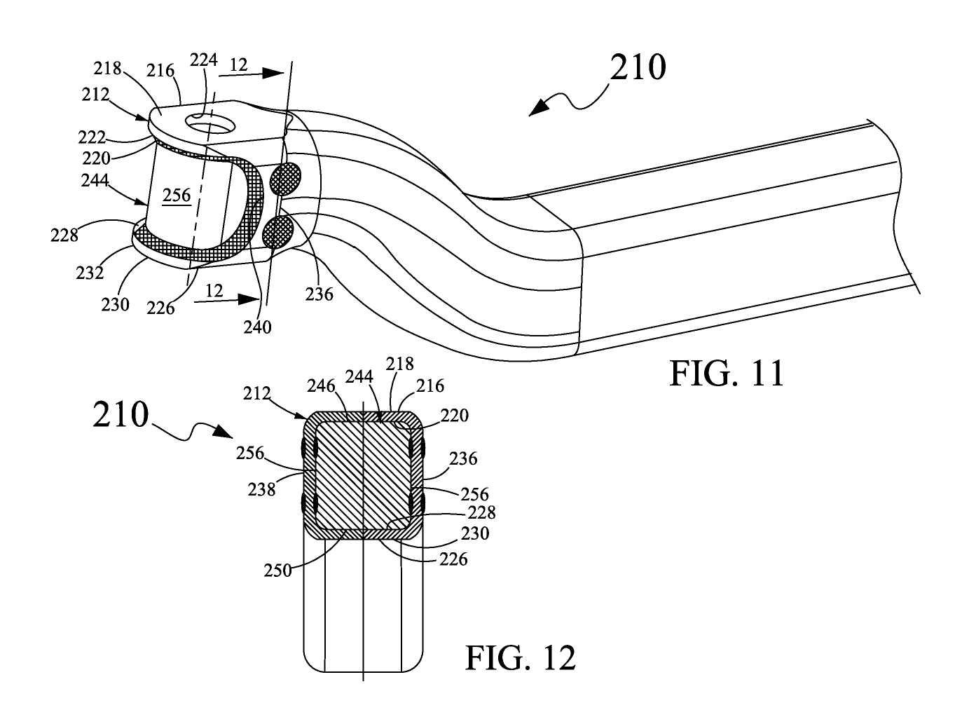

Referring to FIGS. 11 and 12, another embodiment of a steering axle 210 may include a hollow axle tube having an end portion 212 and an insert 244 carried by the end portion 212. The steering axle 210 may be substantially similar to the steering axle 10 of FIGS. 2 and 3. However, the sidewalls 256 of the insert 244 may be further joined with the sidewalls 236, 238 of the end portion 212 by point welding.

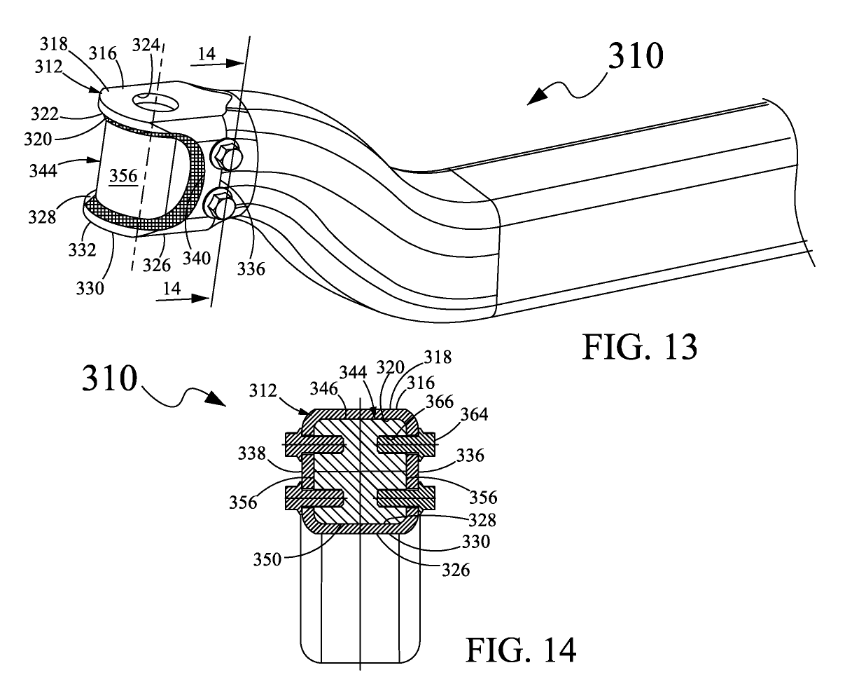

Referring to FIGS. 13 and 14, still another embodiment of a steering axle 310 may include a hollow axle tube having an end portion 312 and an insert 344 carried by the end portion 312. The steering axle 310 may be substantially similar to the steering axle 10 of FIGS. 2 and 3. However, the sidewalls 356 of the insert 344 may be further joined with the sidewalls 336, 338 of the end portion 312 by one or more bolt fasteners 364. In addition, the insert 344 may further have one or more threaded seats 366 receiving a respective one of the bolt fasteners 364.

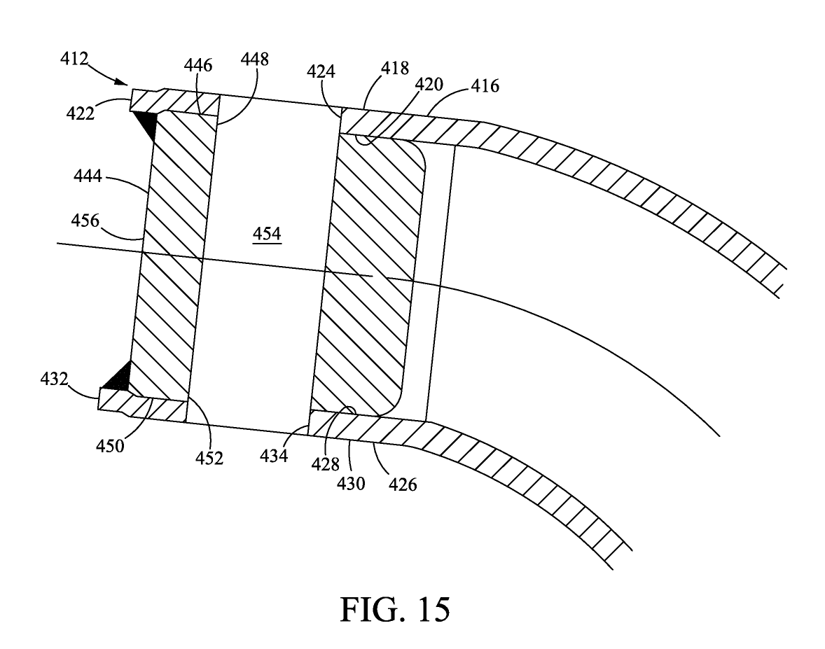

Referring to FIG. 15, another embodiment of a steering axle 410 including an end portion 412 and an insert 444 received within the end portion 412 may be substantially similar to the steering axle 10 of FIGS. 2 and 3. However, the steering axle 410 may have top and bottom walls 416, 426 that may be bent or formed at least partially around the insert 444 to hold the insert 444 in the end portion 412, as compared to joining the insert 44 to the end portion 12 by welding.

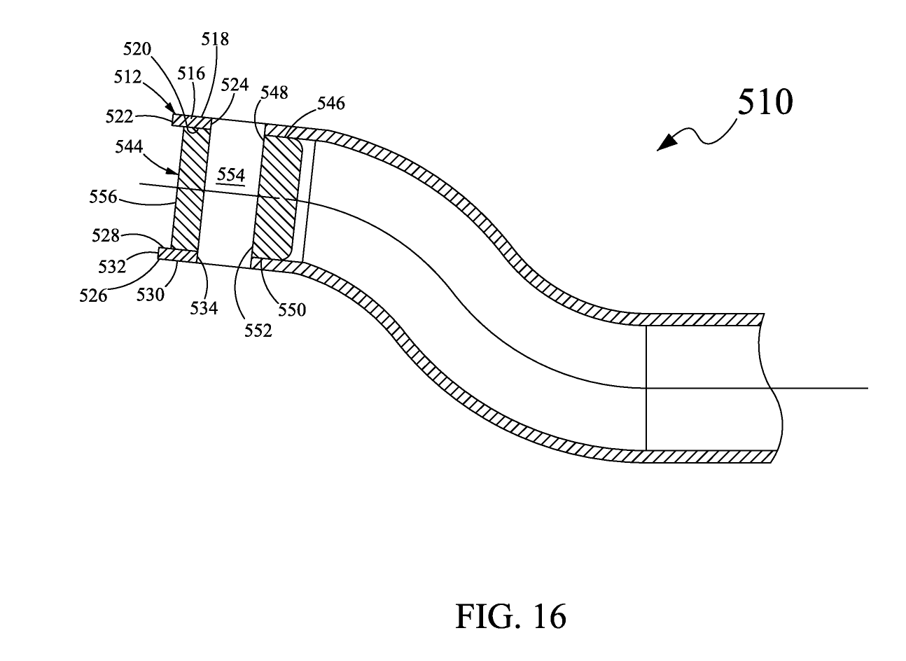

Referring to FIG. 16, another embodiment of a steering axle 510 having an end portion 512 and an insert 544 carried by the end portion 512 is substantially similar to the steering axle 10 of FIGS. 2 and 3. However, the insert 544 may be joined to the end portion 512 by press fitting or the like, as compared to the insert 44 being joined with the end portion 12 by welding. It is contemplated that the inserts may be carried by the end portions by other fastening methods, such as thermal fitting.

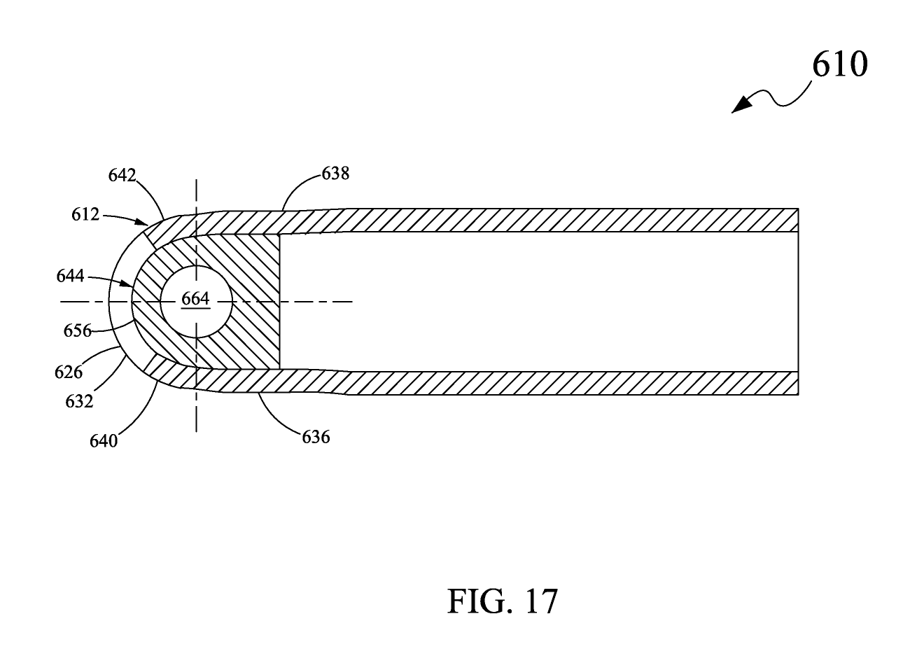

Referring to FIG. 17, another embodiment of a steering axle 610 having an end portion 612 with sidewalls 636, 638 and an insert 644 carried by the end portion 612. The steering axle 610 is substantially similar to the steering axle 10 of FIGS. 2 and 3. However, the sidewalls 636, 638 may have elongated retainers 640, 642, as compared to the concave edges 40, 42. The retainers 640, 642 in one form may be tabs that may extend from a respective one of sidewalls 636, 638 and be bent or partially formed around the insert 644 to hold the insert 644 within the end portion 612.

Referring back to FIG. 2, the steering axle 10 may have a vertically offset configuration such that the end portions 12, 14 are elevated with respect to an intermediate portion of the steering axle 10 that may be in connection between the end portions 12, 14.

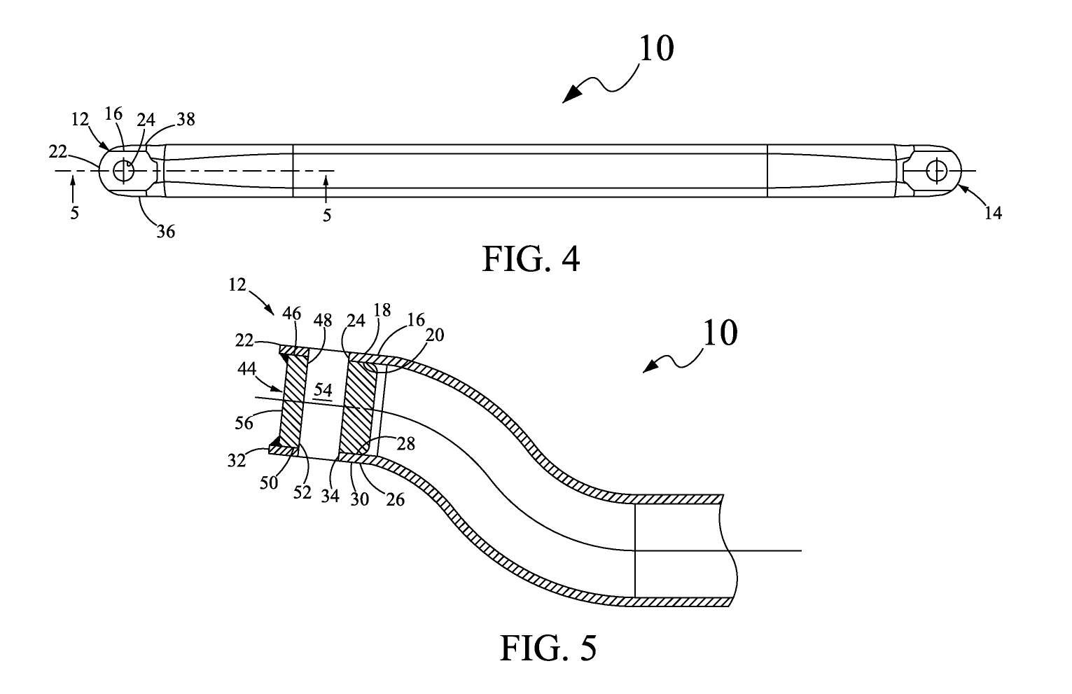

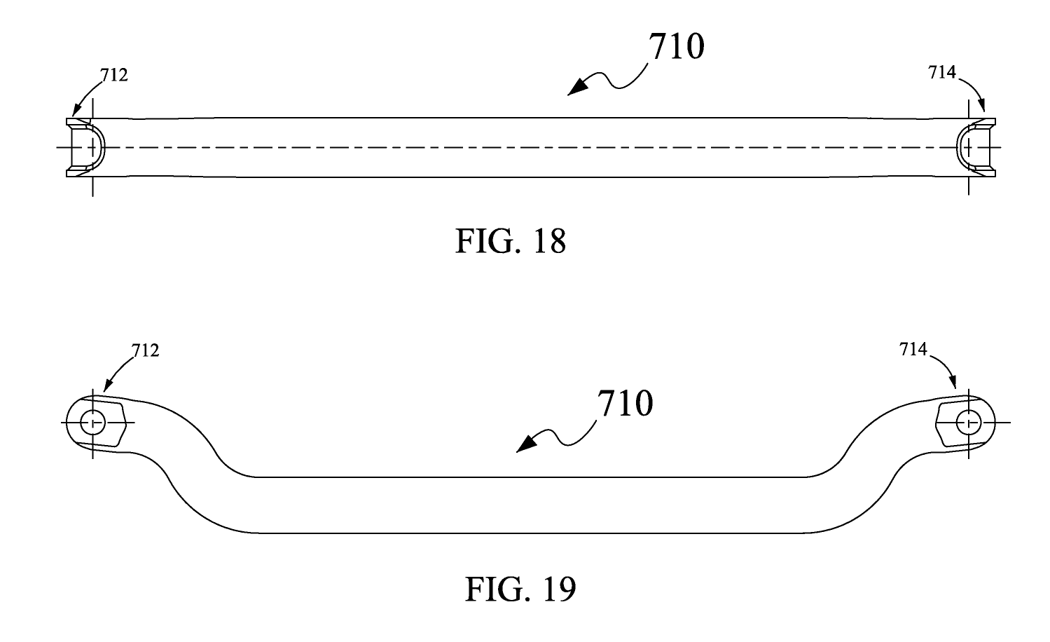

Referring to FIGS. 18 and 19, another embodiment of the steering axle 710 having end portions 712, 714 may be substantially similar to the steering axle 10 of FIGS. 2 and 4 having end portions 12, 14, respectively. However, the steering axle 710 may have a horizontally offset configuration as compared to the vertically offset configuration. For example, the end portions 712, 714 may be offset either fore or aft of an intermediate portion of the axle 710 that may be in connection between the end portions 712, 714.

The steering axle may be advantageous for reducing high-stress welding and long length welding of kingpin bosses in welded beams of steering axles. In addition, the inserts may be quickly joined to the end portions of the steering axle thereby reducing manufacturing cycle time and costs.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the present disclosure and various embodiments with various modifications as are suited to the particular use contemplated.

What is claimed is:

1. A steering axle, comprising:
a hollow tube having a pair of end portions; and
a pair of inserts coupled to a respective one of the pair of end portions.

2. The steering axle of claim 1 wherein the pair of inserts are welded to a respective one of the end portions.

3. The steering axle of claim 1 wherein the pair of inserts is coupled to a respective one of the end portions by plug welding.

4. The steering axle of claim 1 wherein the pair of inserts is coupled to a respective one of the end portions by point welding.

5. The steering axle of claim 1 wherein the pair of inserts is press fitted within a respective one of the end portions.

6. The steering axle of claim 1 wherein the pair of end portions has at least one wall bent around a respective one of the inserts.

7. The steering axle of claim 1 wherein each of the end portions has a top wall, a bottom wall and a pair of sidewalls extending between the top and bottom walls, such that the insert is received between the top wall, the bottom wall and the sidewalls.

8. The steering axle of claim 7 wherein each of the top and bottom walls of the hollow tube has an inner surface that is welded to the insert.

9. The steering axle of claim 7 wherein each the sidewalls terminates with a concave edge that is welded to the insert.

10. The steering axle of claim 1 wherein the hollow tube has an intermediate portion in connection between the pair of end portions, and the hollow tube has a vertically offset configuration such that the pair of end portions is elevated with respect to the intermediate portion.

11. The steering axle of claim 1 wherein the hollow tube has an intermediate portion in connection between the pair of end portions, and the hollow tube has a horizontally offset configuration such that the pair of end portions is offset in one of a fore direction or an aft direction with respect to the intermediate portion.
